(19) United States
(12) Patent Application Publication
(10) Pub. No.: US 2008/0186142 A1
(43) Pub. Date: Aug. 7, 2008

(54) METHOD AND APPARATUS FOR ALLOCATING IDENTIFICATION TAGS TO BUS SUBSCRIBERS ON A DATA BUS AND DEVICE WITH BUS SUBSCRIBERS PROVIDED FOR THE SAME

(75) Inventors: Elmar Herweg, Oberderdingen (DE); Frank Bohm, Sulzfeld (DE); Bernhard Roth, Oberderdingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. ELEKTRO-GERAETEBAU GMBH, Oberderdingen (DE)

(21) Appl. No.: 12/056,809

(22) Filed: Mar. 27, 2008

Related U.S. Application Data
(63) Continuation of application No. PCT/EP2006/009117, filed on Sep. 20, 2006.

(30) Foreign Application Priority Data
Sep. 27, 2005 (DE) 10 2005 047 378.4

(51) Int. Cl. H04Q 5/22; A47J 36/00

(52) U.S. Cl. 340/10.1; 99/325

(57) ABSTRACT

Identification tags are allocated to devices comprising bus subscribers (12a-d) on a data bus (18). The bus subscriber devices are designed with receivers (24a-d) which are designed to receive wirelessly transmitted signals (31) from a transmitter providing the identification tags. These receivers are used to assign an identification tag to the bus subscribers temporarily or permanently before the bus is operation in a normal operating mode for the hob. The invention also covers a method and an apparatus for allocating identification tags to such bus subscribers.

### CROSS REFERENCE TO RELATED APPLICATIONS

This application is a continuation of PCT/EP2006/009117, filed Sep. 20, 2006, which in turn claims priority to DE 10 2005 047 378.4, filed on Sep. 27, 2005, the contents of both of which are incorporated by reference.

### FIELD OF THE INVENTION

The invention relates to a method for giving unique identification tags to bus subscribers on a data bus, an apparatus for giving identification tags to a device with a data bus and with bus subscribers connected to the data bus, as well as such a device.

### BACKGROUND OF THE INVENTION

Data bus systems are used for bringing correlated electronic components in such a position that they can communicate with one another. They are e.g. used in devices so that individual components thereof can communicate with one another or with a mainframe computer.

The structure of a data bus system is technically implemented by means of a signal-transmitting connecting means, e.g., using a data bus cable, as well as components, namely the bus subscribers, connected to said connecting means. In order to modify the structure of the data bus system with respect to its bus subscribers, individual bus subscribers can at any time be additionally connected to the data bus or existing bus subscribers can be separated therefrom.

In order to be able to detect in the case of data which are written on the data bus which of the bus subscribers has written said data or to which bus subscriber said data are directed, unique identification tags are allocated to the bus subscribers. This makes it possible to determine the transmitter and the designated receiver for data transmitted on the data bus.

There are numerous technical possibilities for allocating said unique identification tags. According to the simplest possibility, prior to the putting into operation of the data bus the in each case unique identification tag is set on the individual bus subscribers and this can e.g., take place by means of jumpers or DIP switches. A disadvantage of this solution is that setting the switches or jumpers involves considerable effort and expenditure. This particularly applies when bus subscribers of the same type are connected to a data bus, because this generally involves the setting of the bus subscribers during installation, or following the installation of the bus subscribers in the device containing the data bus. However, this undesirably increases complication during manufacture of the devices. As an alternative, when using several subscribers of the same type on the data bus it is also possible to provide said bus subscribers outside and prior to assembly with in each case a unique identification tag. However, this means that the identical bus subscribers must be kept separately held in stock and handled as a function of the set, unique identification tag, so as to ensure that accidentally two bus subscribers with the same identification tag are not connected to one data bus.

In addition to the manual allocation of identification tags, it is also known to automatically give the identification tags in the data bus. This is known, for example, under the name “SCAM” (SCSI Configuration Auto-Magically) for the SCSI data bus normally used in the EDP sector. However, particularly when identical bus subscribers are used, this method is only appropriate for use if it is unimportant for the intended use as to which bus subscriber receives which identification tag. However, with such systems in which identical bus subscribers are built up, and during operation in a planned manner one or other bus subscriber must be designatable, without subsequent configuration steps, such an automatic allocation of identification tags cannot be used.

### BRIEF DESCRIPTION OF THE DRAWINGS

Embodiments of the invention are described hereinafter relative to the attached diagrammatic drawings, wherein:

FIG. 1 illustrates an first embodiment of an inventive device constructed as a hob, in a part sectional view;

FIG. 2 illustrates an embodiment of a first variant of the inventive method with the hob shown in FIG. 1;

FIG. 3 illustrates an embodiment of the signal patterns of the signal emitted by a transmitter, as well as the signals received by the hotplate receivers of the hob according to FIGS. 1 and 2;

FIG. 4 illustrates a second embodiment of an inventive device constructed as a hob in a sectional view;

FIG. 5 illustrates a second embodiment of the inventive method when used on the hob shown in FIG. 3;

FIG. 6 illustrates an embodiment of the signal patterns of the signal emitted by a transmitter when applying the second variant of the inventive method according to FIG. 5, as well as the signals received by the hotplate receivers;

FIG. 7 illustrates a first embodiment of an inventive apparatus for allocating identification tags to a device equipped with a data bus and bus subscribers; and

FIG. 8 illustrates a second embodiment of an inventive apparatus for allocating identification tags to a device equipped with a data bus and bus subscribers.

### DETAILED DESCRIPTION OF THE EMBODIMENTS

The problem solved by one embodiment of the invention is to provide a method for assigning unique identification tags to bus subscribers on a data bus, which each then used by each subscriber. A further embodiment provides an apparatus suitable for performing the method, as well as devices with data bus systems enabling the method to be performed.

Advantageous and preferred developments of the invention form the subject matter of the further claims and are explained in greater detail hereinafter. By express reference the wording of the claims is made into part of the content of the description. Some of the subsequently described features are admittedly only explained once, but independently of this, they apply both to the method, the device and the allocating apparatus.

According to one embodiment of the invention, a method is defined for giving unique identification tags to the bus subscribers on a data bus and where in a location-dependent manner, a wireless receivable signal is emitted by means of a transmitter, the bus subscriber receives the signal and the bus subscriber is allocated its identification tag as a function of the signal received.

A bus subscriber suitable for performing the method has for this purpose a receiver suitable for receiving wireless emitted signals. Said receiver is preferably constructed as part of, or is connected to, a bus controller. Before the data bus system is put into operation, said receiver is used in order to give the bus subscriber its identification tag with which it can participate in the performance of its correct functions on the data traffic on the data bus. Providing the identification tag is accomplished by a signal emitted by a transmitter, which can be constructed both as a transmitter which is completely separated from the data bus, as a transmitter fixed in the data bus, or only briefly integrated therein for configuration purposes. By means of the signal strength and other signal-specific parameters, the bus subscriber can detect whether the signal is intended to provide it with the information necessary for allocating an identification tag. Thus, the bus subscriber can ignore certain signals such as those with a signal strength below a specific boundary signal strength, or not use those signals for identification tag determination which do not follow a fixed signaling protocol. However, if the bus subscriber has determined that the received signal is intended for establishing its own identification tag, by means of preset algorithms, it can use the signal parameters for determining its preset identification tag. It is considered particularly advantageous if the bus subscriber can derive, without interaction with other bus subscribers, and via the data bus, its identification tag from the signal received. Thus, identification tags can be allocated prior to putting into operation or even prior to the installation of the data bus. It is also conceivable and appropriate in some embodiments of the invention for the bus subscriber to transfer via the data bus, the signal received and the parameters thereof, e.g. regarding the signal strength, to other bus subscribers. The actual identification tag is established by a central means on the data bus, which fixes the identification tag and transmits it back to the bus subscriber.

The inventive method makes it possible in the case of a device, or device union with a data bus, whose components are designed as data bus subscribers, to only allocate identification tags following the end of the assembly of the apparatus. Thus, during assembly there is no need to take account of having to provide in the apparatus identical components with different identification tags in different ways or at different positions. Instead, only following assembly is there a type of characterization or definition of the bus subscribers, in which the bus subscribers are provided with function/position-specific identification tags depending on their actual function or position for, or in which they are installed. This definition of the bus subscribers can be performed once and for all following assembly or during each new putting into operation of the apparatus, e.g., and more particularly through a transmitter constructed as part of the apparatus.

In a further embodiment of the inventive method the identification tag is coded in the emitted signal. This represents the simplest solution with respect to the determination of the identification tag by the bus subscriber. In this case the transmitter transmits a signal, which is directly influenced by it with respect to its content as to which identification tag is thereby transmitted. In order to ensure that several bus subscribers do not use said signal for determining their particular identification tag, the signal must be emitted in such a way that it only reaches with a relevant signal strength the particular bus subscriber provided for determining its identification tag. This can e.g. take place by a signal with a limited range or planned direction, or also by a planned shielding of the other bus subscribers with respect to the transmitter. This signal does not have to directly contain the identification tag. Instead, it is also possible for the identification tag to only be fixed in conjunction with information contained in the data bus system and particularly in the bus subscriber. For example, each bus subscriber can have an allocation table, in which an identification tag is allocated to each possible subscriber function. If the bus subscriber takes the allocated function for itself from the received signal, in conjunction with the allocation table, the subscriber can also determine its identification tag.

According to a further embodiment of the method, after determining its identification tag, the bus subscriber files it in a memory, particularly a non-volatile memory. This makes it possible to secure the identification tag permanently or at least for the duration of uninterrupted power supply in the bus subscriber. When non-volatile memories are used, a once given identification tag can be retained for the life of the bus subscriber. As the non-volatile memory it is advantageous to use a memory which maintains its content without a power supply, e.g. EPROM, EEPROM or FLASH-EEPROM. However, alternatively a volatile memory is also suitable and it can be designed for the storage of the identification tag when the device or data bus system is switched off by means of a permanent power supply, e.g. a backup battery.

In a further embodiment of the invention, the bus subscriber uses the received signal for determining its identification tag only if the signal strength has exceeded a fixed limit value. A signal below said limit value is interpreted as not intended for the bus subscriber and is therefore ignored. It is particularly advantageous if the bus subscriber, e.g., through LEDs or acoustic outputting means, makes it clear whether it has classified a signal as being above or below the limited value.

In a further embodiment of the invention, several subscribers in succession or simultaneously are accommodate in each case by a signal emitted by one or more transmitters. The bus subscribers are so widely spaced from one another that each bus subscriber only uses the signal allocated to it for determining its identification tag. Thus, the bus subscribers are so far apart that a signal intended for a first bus subscriber is ignored by a second bus subscriber, because it is not considered to be strong enough. The choice of transmitter and the arrangement of the bus subscribers can be used for fixing a limit value below which a signal strength leads to the particular signal being ignored.

In a further development, only one transmitter is used and which successively and from differing positions relative to the bus subscribers emits a single signal for each bus subscriber. This is a simple solution with respect to the transmitter. Independently of the number of bus subscribers, only one transmitter is needed and said transmitter requires no special arrangements to ensure that in each case a single bus subscriber makes use of the signal emitted by the transmitter for determining its identification tag. The allocation of the signals emitted by the transmitter to the in each case designated bus subscribers is brought about in that the transmitter and the in each case designated bus subscriber are brought into the immediate vicinity of one another, so that only for the designated bus subscriber is the signal strength adequately high for determining the identification tag. Depending on the intended use and in particular the numbers of bus subscribers to be defined, it can be appropriate to design the transmitter as a mobile hand set or as automatically guided or moved transmitters.

In a further embodiment of the method, a single transmitter is used, which emits from a fixed position relative to the bus subscribers in each case, a single signal wherein the emission direction of the signal being specific or fixed for each signal. The use of such a method is advantageous in that there is no need for a relative movement of the transmitter with respect to the bus subscribers and this is replaced by fixing the transmission direction. This embodiment of the inventive method is particularly suitable in the case of high frequency, electromagnetic signals. Thus, e.g., when using light signals, a fixing of the transmission direction can be very easily implemented by a radiation direction-restricting attachment upstream of the light transmitter or a directional light transmitter.

In a further embodiment of the method, a single transmitter is used for each bus subscriber and the transmitters are preferably positioned in congruent manner to the bus subscribers. In this development of the method, a specific transmitter is allocated to each bus subscriber and is so designed, positioned and oriented that the signal emitted by it is only used in each case by the designated bus subscriber for determining the bus subscriber-specific identification tag. The advantage of this method is that the allocation of the identification tags by the bus subscribers can take place simultaneously and therefore very rapidly. The transmitters are preferably part of a tool apparatus, which with respect to its shaping is adapted to the apparatus, whose bus subscribers are to be given identification tags.

According to a further embodiment of the invention, during the allocation or determination of identification tags the bus subscribers are connected to the data bus. A data bus communication takes place for coordinating, monitoring and/or plausibility checking of the allocation or determination. This data bus communication can e.g., involve a mainframe computer connected to the data bus transmitting to the latter a waking or ringing signal before emitted signals from the transmitter are expected for the purpose of identification tag determination. As a result, signals registered by the receivers are ignored which should have no influence on the bus subscriber identification tag, such as e.g., signals serving to allocate identification tags to another data bus. This data bus communication can also be used for error or fault detection, e.g., if the bus subscriber is so constructed that following the determination of its own identification tag it transmits a signal to the data bus. This makes it possible to establish whether erroneously a signal for allocating identification tags has been used by no bus subscriber or more than one bus subscriber for determining its own unique identification tag. It is also appropriate, following the emission of a signal by the transmitter, for the bus subscribers to transmit to the data bus a characteristic value representing the signal strength received and to read out the characteristic values of the other bus subscribers from the data bus. Thus, the device with the highest signal strength recognizes that it is the closest to the transmitter and therefore the addressee of the signal.

In a further embodiment of the invention, the identification tag is determined from the strength of the signals received. If the bus subscriber is aware of the strength of the emitted signal, through evaluating the received signal strength it is possible for it to determine the distance from the transmitter. This knowledge of the distance can be used by the bus subscriber for drawing conclusions regarding its own position within the apparatus of which it forms part. The identification tag can then be allocated by the bus subscriber as a function of this position.

In a further development of the invention, different possible identification tags are filed in the bus subscriber and with each of which is associated a signal strength range. The determination of the identification tag by the bus subscriber takes place as a function of the particular signal strength range in which the received signal is located. The signal strength ranges are preferably so predetermined that one signal strength range is allocated to each possible position of a bus subscriber in the data bus system or in the data bus-containing device. Thus, a bus subscriber can gather from the determined, received signal strength in a direct manner its identification tag without having to draw conclusions regarding its distance from the transmitter.

In a further embodiment of the method several bus subscribers are excited by a common signal for determining their particular identification tag. The transmitter is so positioned relative to the bus subscribers and the signal is so designed with regards to its nature and output strength, that the common signal is associated with different signal strength ranges for each of the bus subscribers.

For this purpose, the transmitter is so positioned that in each case the expected signal strengths received by the bus subscribers are as different as possible from one another. The arrangement of the signal strength ranges, which is identical for all bus subscribers, is preferably such that the received signal strength expected in the case of the different bus subscribers is in each case roughly in the middle of the signal strength ranges. The bus subscribers receive the emitted signal with different strengths, seek from the signal strength range arrangement common to all the particular range in which the signal strength received by them is located. As a single identification tag is allocated to each signal strength range, the bus subscribers in each case determine a different identification tag as their own identification tag.

In a further embodiment of the invention, several bus subscribers are excited by a common signal for determining their identification tags. After the receipt of the common signal, the bus subscribers transmit their signal strength as a characteristic value to the data bus and on the basis of the comparison with the received signal strengths of the other bus subscribers determine their identification tags. Thus, even before they have their own identification tag, the bus subscribers transmit to the data bus a value formed by the received signal strength. This can take place in random order. Collisions of simultaneously transmitting bus subscribers can be prevented by standard collision prevention methods. After all the bus subscribers have transmitted to the data bus their signal strength or a value representing said signal strength and therefore each bus subscriber knows the received signal strengths of the other bus subscribers, then each bus subscriber can establish it distance from the transmitted to the other bus subscribers on the basis of the relevant classification of the signal strength from the transmitter relative to the other bus subscribers. This enables it to establish its own identification number on the basis of a fixed, predetermined logic identical for all bus subscribers. Thus, e.g. a bus subscriber which has determined the third strongest signal strength can choose as the identification tag “3”. As an alternative to providing the identification tag as a function of the received signal strength received by the other bus subscribers, it is also possible to allocate the identification tag allocation function to a mainstream computer. The latter acquires knowledge of all the received signal strengths by reading out the data bus communication, then allocates each signal strength an identification tag and transmits said allocations to the data bus in such a way that each bus subscriber acquires a corresponding identification tag to the signal strength determined by it.

In a further embodiment of the invention, the transmitter or transmitters transmit electromagnetic signals. Preferably use is made of electromagnetic signals in the normal radio frequency range or also in the infrared or visible light range. By means of passive receivers, it is also possible to give identification tags to receivers without requiring the receivers being connected to a power supply. This increases flexibility regarding the assembly order, because even prior to the integration of the data bus or a power supply, the definition of the bus subscribers can take place.

In another embodiment of the invention, the transmitter or transmitters transmit inductive or capacitive signals. This is particularly advantageous if the bus subscribers are to be excited by their own signals for establishing their identification tag. Standard inductive and capacitive signals have a limited range, so it is ensured that signals intended for a specific bus subscriber are not incorrectly interpreted by other bus subscribers as being intended for them.

In another embodiment of the invention, the signals vary with respect to frequency, pulse, length, signal duration and/or signal strength on transmitting several signals by one or more transmitters. These parameters can be easily identified by the corresponding receivers in the bus subscribers, so that conclusions can be drawn regarding the identification tag to be given with limited technical expenditure on the side of the bus subscriber.

In a further embodiment of the method the signal or signals have a fixed form, particularly with a fixed initializing frequency. Other signals not having this fixed form, are not used by the bus subscribers for determining their particular identification tag. This makes it possible to exclude the incorrect use for identification tag allocation of signals not intended for fixing identification tags and which e.g., emanate from other transmitters such as radio-transmitters, radio-based computer networks, radiotelephones, etc. In the simplest case, this can be brought by a starting frequency, e.g. in the form of a periodic square-wave signal of predetermined frequency.

In a further embodiment of the method, the latter is performed once during the manufacture of a device containing the data bus and bus subscribers. Only a single definition of the device is carried out during manufacture. Thus, the defined bus subscribers retain the fixed identification tag over their entire life. It is particularly advantageous in this connection that a transmitting device integrated into the apparatus is not needed for recurrent new allocation of identification tags. This single definition during manufacture can be implemented by a tool adapted to the device to be manufactured and having one or more transmitters.

In yet another embodiment of the invention, the method is performed repeatedly, particularly on each putting into operation of the device containing the data bus and bus subscribers or the data bus. This is advantageous if the bus subscribers have to be replaced during the life of the device, e.g. due to wear. Particularly in the case of data bus systems with numerous data bus components, where the failure of individual components is an every day occurrence, this development of the method is advantageous. When applying this method with repeated identification tag allocation, the replacement bus subscribers do not have to be placed in planned manner at a predetermined identification tag and instead receive the tag when the data bus is put into operation.

In a further embodiment of the invention, the bus subscribers are heating elements of a heating device, particularly hotplates or advantageously individual induction devices of a hob as the device. The basic problem of the invention occurs particularly clearly in this field. In the case of hobs, as a function of the embodiment, there are normally between four and seven hotplates, e.g. equipped with heat radiators or advantageously induction heating devices, which can be positioned in numerous different ways. The hotplates are frequently of the same type. In order not to allocate to the hotplates an identification tag prior to installation in the hob, which would greatly increase the cost of the manufacturing process, the hotplates are integrated without a unique identification tag into the hob during manufacture and are connected by a data bus. Only then and using the inventive method is an identification tag allocated and as a result the identification tags of the individual hotplates are identical in different hobs of the same type. Thus, the hotplates always have the same identification tags, e.g. a left, rear hotplate could always have the identification tag “4”, whereas the hotplate at the left, front in front of the same would always have the identification tag “3”. A control unit connected to the data bus and which knows the allocation of the identification tags over the different hotplates, can therefore allocate inputs of an operator, such as e.g. “cooking stage 6 for hotplate left, rear” to the correct identification tag “4” and transmit with said tag a corresponding signal on the data bus.

One embodiment of the invention also relates to a device with several electronic modules as bus subscribers, which are interconnected by means of a common data bus, each of the modules having a signal receiver for receiving wireless transmitted signals. The device has at least one evaluating unit which on the basis of received signals allocates to the modules in each case a unique identification tag.

Despite the necessary signal receivers and the associated logics in the form of one or more evaluating units, the manufacture of such a device is comparatively advantageous, because it is unnecessary on assembling the modules, with respect to the identification tags, to use already configured modules or to configure them manually in the assembled state. Instead the device finished assembly of the device takes place and only subsequently is it defined with identification tags for the modules. The evaluating device(s) makes it possible on the basis of the signals received by the signal receivers or on the basis of their parameters, to draw conclusions as to which identification tag is to be allocated to a given module. In this connection the term “device” relates to an arrangement with several modules housed on or in a unitary housing or casing. However, this definition of a device also covers an arrangement of different, spatially separated modules, such as machines designed for operation on a field bus.

In a further embodiment of the invention the device is a hob and the modules are at least in part the hotplates of said hob. Particularly in the case of hobs which are manufactured in large numbers, the inventive definition is appropriate, because the cost increase through the additional receivers is lower than the costs arising during assembly as a result of a manual configuration or the errors which occur.

In a further embodiment of the invention, each module, particularly each hotplate, is associated an individual evaluating device. Thus, each module, even before it transmits on the data bus for the first time and optionally even before it is connected to the data bus, can in a very reliable manner obtain its own identification tag from the parameters of the signal received.

One embodiment of the invention also relates to a device for giving or allocating identification tags to bus subscribers of an apparatus, which is equipped with a data bus to which the bus subscribers are connected, particularly for allocating identification tags to a finished assembled hob with several hotplates. For allocating identification tags the apparatus has a receptacle for the device and at least one transmitter for emitting wireless signals, by means of which one or more bus subscribers can determine their own identification tag.

The device, whose bus subscribers are to be provided with identification tags, is received in the receptacle in such a way that the bus subscribers are fixed from the position standpoint relative to the device and also remain in a clearly defined position relative to the identification tag allocation apparatus. Subsequently, the transmitter emits one or more signals, which are determined for an individual bus subscriber or for several bus subscribers and which can be used for determining the particular identification tags of the bus subscribers.

These and further features of the invention can be gathered from the claims, description and drawings and the individual features, both singly or in the form of subcombinations, can be implemented in an embodiment of the invention and in other fields and can be in the form of advantageous constructions for which protection is claimed here. The subdivision of the application into sections and the subheadings in no way restrict the general validity of the statements made thereunder.

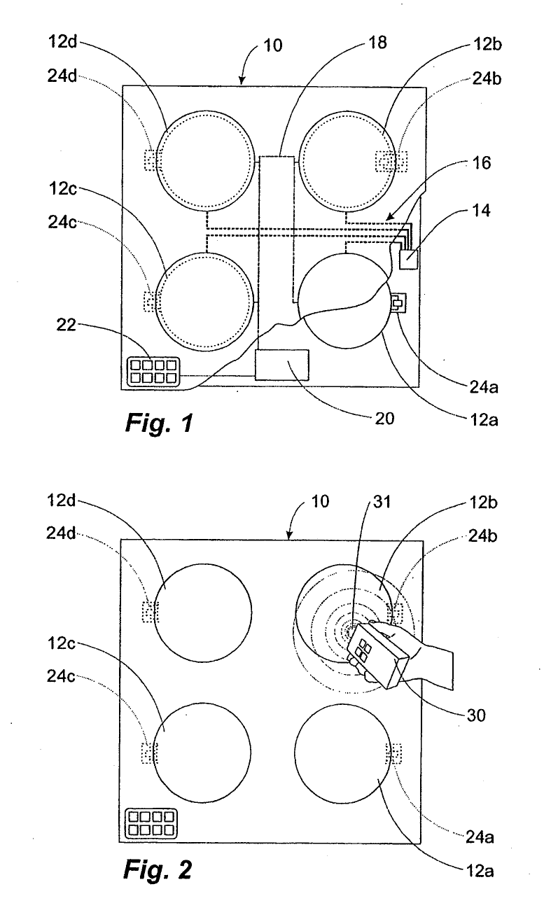

Turning now to the figures, FIGS. 1 and 2 show a hob 10 with four hotplates 12a-d constructed as heat radiators. Hob 10 is equipped in conventional manner with a power connection 14, from which radial lines 16 lead to the individual hotplates 12a-d. By means of said power connection 14 and the lines 16, the hotplates 12 receive the power necessary for the heating operation. Once again in conventional manner, the hob 10 also has a data bus 18 interconnecting the individual hotplates 12a-d. For communication with the data bus 18, each of the hotplates 12a-d has a control unit with bus controller, not shown in FIGS. 1 and 2, connected in bus subscriber form with the data bus 18. Data bus 18 is also connected to a central control unit 20, which is in turn connected to a keyboard 22 by means of which an operator can give control instructions.

Diverging from conventional hobs, the hob shown in FIG. 1 has for each hotplate 12a-d, a receiver module 24a-d, wherein each module 24 is directly associated with a hotplate 12a-d and is positioned in the immediate vicinity thereof. The receiver modules 24a-d are connected (not shown) to the particular control unit of hotplates 12a-d, which also have in each case a memory, which is used for receiving a unique identification tag specific to each hotplate.

The state shown in FIG. 1 is that following assembly and prior to the first putting into operation of hob 10. At this time, no identification tag has as yet been allocated to hotplates 12a-d. Hotplates 12 are identical to one another and consequently a specific response of an individual hotplate 12a-d by means of central control unit 20 is not yet possible.

FIG. 2 shows the allocation of an identification tag following the assembly of hob 10. This allocation is implemented by means of a manual transmitter 30, which during the monitoring of the finished hob 10 is successively brought into a transmitting mode by means of a hotplate 12a-d in which it transmits a signal 31, in which is coded the identification tag provided for the given hotplate. The identification tag to be transmitted can be set on the manual transmitter 30. The receivers 24a-d of hotplates 12a-d receive said emitted signal 31 of transmitter 30 and in a reaction to the receptacle check whether the signal 31 has exceeded a given limit signal strength. If this limit or boundary signal strength has been exceeded, then the control unit of the given hotplate 12 interprets the signal as being intended for the particular hotplate. Should the control unit of one of the hotplates 12a-d decide that the signal 31 is intended for the hotplate associated therewith, it analyzes the signal with respect to the coded identification tag therein and writes the same in the memory associated with the control unit.

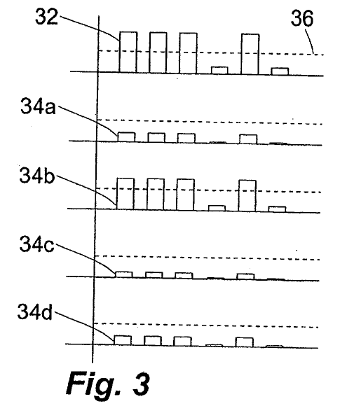

FIG. 3 shows the signal pattern of the signal 31 emitted by transmitter 30 and the signal patterns 34a-d of the signals received by receivers 24a-d. In addition, FIG. 3 shows in broken line form the signal strength limit value 36 below which signals from the given control unit of hotplates 12a-d are interpreted as not being directed to the given hotplate 12.

As is shown by the signal pattern 32 of signal 31, the signal 31 emitted by transmitter 30 starts with three rectangular peaks, which are independent of the identification tag coded in each case. These three peaks are used for enabling the receivers or control units of hotplates 12a-d to detect whether the signal received is a signal for setting the identification tag. They also have the function, on the basis of their signal strength, of enabling the control units of the individual hotplates 12a-d to evaluate whether the signal is strong enough for an evaluation. The signal patterns 34a-d of the received signal 31 make it possible to detect that the signal strength clearly varies as a function of the distance between receiver and transmitter. The signal patterns 34a, 34c, 34d received by receivers 24a, 24c, 24d in each case do not exceed the limit signal strength 36. Only the signal pattern 36b received by receiver 24b of hotplate 12b exceeds with its three introductory peaks the limit signal strength 36. This indicates to the control unit of hotplate 24b that the subsequently coded identification tag is intended for hotplate 12b. Whereas the control units of hotplates 12a, 12c, 12d no longer carry out a more profound analysis of the following part of the signal pattern, said part is analyzed by the control unit of hotplate 12b and it is recognized that the bit sequence “low-high-low” is involved. This bit sequence is then written by the control unit into the associated memory. The bit sequence “low-high-low” corresponds to the binary coding of identification tag “2”. Thus, the hotplate 12b receives identification tag “2”.

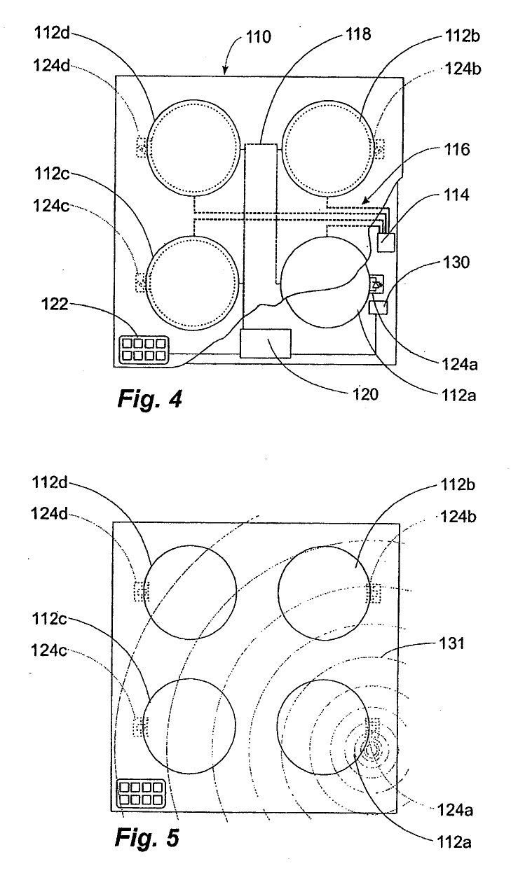

FIGS. 4 and 5 show a second embodiment of an inventive hob, which is prepared for performing the inventive method for allocating unique identification tags.

Like the hob 10 shown in FIGS. 1 and 2, the hob 110 shown in FIGS. 4 and 5 has four hotplates 112a-d, which on the one hand are radial with a power connection 114 and on the other are connected via a data bus 118 to a central control unit 120. Like the hotplates 12 of FIGS. 1 and 2, the hotplates 112a-d of FIGS. 4 and 5 in each case have a receiver 124a-d and a control unit, not shown in FIGS. 4 and 5, with a memory provided for the identification tags of the particular hotplates 112a-d. Diverging from the first embodiment of FIGS. 1 and 2, the hob 110 shown in FIGS. 4 and 5 has an integrated transmitter 130 directly connected to the central control unit 120.

FIG. 4 shows hob 110 in the finished assembled state, no identification tag having as yet been allocated to the hotplates. Unlike in the case of the first embodiment of FIGS. 1 and 2, this is not brought about by permanent fixing during manufacture of the hob and instead hob 110 is designed to allocate the identification tags anew during each putting into operation.

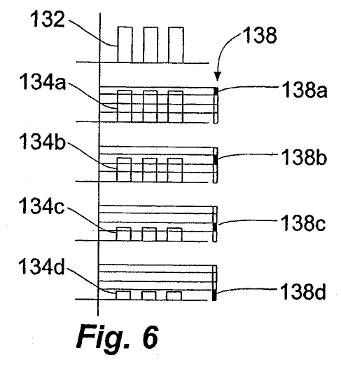

The way in which this takes place is shown in FIGS. 5 and 6. After switching on hob 110, the central control unit 120 makes transmitter 130 transmit a signal 131, which is received by receivers 124a-d and interpreted in different ways.

FIG. 6 shows the signal pattern 132 of the signal 131 transmitted by transmitter 130. It is a square-wave signal with in all three successive signal peaks. The signal patterns 134a-d are those received by the receivers 124a-d of hotplates 112a-d. Due to the differing distance of receivers 124 from transmitter 130, the signals are attenuated to a different extent. Whereas the signal pattern 134a recorded by receiver 124a still approximately reaches the signal strength of output signal 132, because the receiver 124a is positioned directly alongside transmitter 130, the signals received by receivers 124b-d have much more attenuated signal patterns. Diverging from the method used relative to the hob 10 of FIGS. 1 and 2, the control units of hob 110 aim at in each case using the signal 131 independently of its signal strength for determining an identification tag provided that, as in the present case, it is a square-wave signal 131 with three signal peaks. Each of the control units of hotplates 12a-d has a table in which different signal strength ranges are allocated to in each case one specific identification tag. After signal 131 has been received by receivers 124a-d, the control units of the hotplates determine in which of the signal strength ranges the received signal strength is located. In FIG. 6 the range subdivision can be gathered from the range scale 138 shown to the right of the received signals. It can be seen that the signal strength determined by receiver 124a is in the top range 138a of said scale. Thus, the control unit of hotplate 112a writes the identification tag “1” associated with this top range 138a in its memory. The control units of hotplates 112b-d operate in the same way and the hotplate 112b receives identification tag “2”, which is associated with the second range 138b, the hotplate 112c the identification tag “3”, associated with the third range 138c and the hotplate 112d the identification tag “4” associated with the fourth range 138d.

In this second variant of the inventive method it is consequently possible with only a single signal to allocate identification tags to all the hotplates.

In another variant (not shown) of this method represented in conjunction with FIGS. 4 to 6, the given control device of the hotplates determines the identification tag in that the received signal strength is written on the data bus accompanied by simultaneous reading from the data bus, instead of on the basis of a table with signal strength ranges. In this way the control units of all the hotplates establish which signal strengths have been recorded by the other receivers. They can subsequently establish the identification tag in that the own received signal strength relative to the other received signal strengths is used, so that e.g. the hotplate with the second highest signal strength receives identification tag “2”.

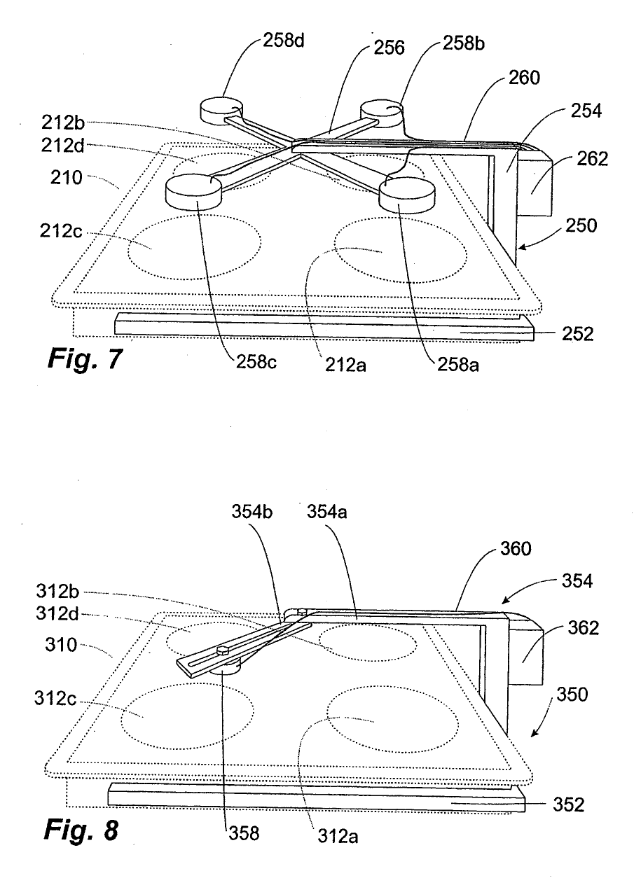

FIGS. 7 and 8 show embodiments of apparatuses for allocating identification tags to devices equipped with a data bus and bus subscribers connected to the data bus.

The apparatus shown in FIG. 7 is used for allocating identification tags to hobs, similar to FIGS. 1 and 2. Apparatus 250 has a receptacle 252 in which is placed a corresponding hob 210. On a bracket arm 254 of apparatus 250 a transmitting device 256 extends over the top of hob 210. This transmitting device 256 has four transmitters 258a, 258b, 258c, 258d, which are connected by cable connections 212 in each case separately to a control unit 214. The transmitters 258a-d are so positioned that in each case they are located above one of the hotplates 212a-d of the fixed hob 210.

The operation of this apparatus largely corresponds to the identification tag allocation explained in conjunction with FIG. 2. Each of the transmitters 258a-d transmits a signal specific to the hotplates 212a-d of hob 210 and which is only detected as having an adequate strength by the intended hotplate. Thus, it is possible for apparatus 250 to simultaneously provide with in each case one identification tag all for hotplates 212a-d of hob 210.

FIG. 8 shows a second embodiment of an apparatus for allocating identification tags to a device with a data bus and bus subscribers connected to the data bus. Like the apparatus shown in FIG. 7, the apparatus 350 has a receptacle 352 and a transmitting device on a bracket arm 354 and which, unlike in the embodiment of FIG. 7, only has one transmitter 358. Transmitter 358 is flexible with respect to its relative position to a fixed hob 310. For this purpose the transmitter 358 is fitted to a front section 354a of bracket arm 354, which is movable relative to an apparatus-fixed, rear section 354b of bracket arm 354 with respect to the angular position. Moreover, the position of transmitter 358 in the extension axis of the front section 354a can be adjusted by a stop screw. The transmitter 358 can consequently be fixed in various positions over receptacle 310.

Apparatus 350 permits the performance of a method for allocating unique identification tags, which is similar to that explained in connection with FIGS. 4 to 6. Diverging therefrom, the transmitter 358 is not part of the hob and the identification tags determined by the hotplate control units are stored permanently.

In a further, not shown embodiment of an apparatus for allocating identification tags once again only one transmitter is provided, but the latter is moved in automated manner, so that it is possible to successively provide with an identification tag the individual hotplates of a hob in accordance with the first embodiment of FIGS. 1 and 2. The advantage of such an embodiment is more particularly the high degree of flexibility.

1. A method for allocating an identification tag to a bus subscriber wherein said bus subscriber is one of a plurality of bus subscribers in a cooking appliance wherein each one of said plurality of subscribers is interconnected to a data bus in said appliance, comprising the steps of:
emitting a position-dependent, wireless signal from a transmitter conveying said identification tag said bus subscribers;
receiving said wireless signal by said bus subscriber; and
storing said identification tag a non-volatile memory associated with said bus subscriber.

2. The method according to claim 1, wherein the identification tag is used to identify a subsequently received control signal for said bus subscriber transmitted by a controller in said appliance to said bus subscriber.

3. The method according to claim 1, wherein said step of storing said identification tag in said non-volatile memory comprises the further steps of:
measuring a signal strength of said wireless signal in an evaluating unit in said bus subscriber; and
ascertaining that said signal strength exceeds a predetermined value.

4. The method according to claim 3, wherein said plurality of bus subscribers are positioned spaced apart in said appliance such that each bus subscriber receives said signal at a respective different signal strength.

5. The method according to claim 3, wherein said transmitter emits said signal with a signal emission direction from a fixed position relative to the plurality of bus subscribers, the signal emission direction being specific to said bus subscriber.

6. The method according to claim 3, wherein prior to the step of storing said identification tag a non-volatile memory associated with said bus subscriber, the following step occurs:
transmitting data on the data bus by said subscriber device wherein said data represents a signal strength value of said wireless signal.

7. The method according to claim 3, wherein the identification tag is determined from the strength of the received signal.

8. The method according to claim 1, further comprising the steps of:
determining a signal strength value of said wireless signal;
emitting a second position-dependent, wireless signal conveying a second identification tag;
receiving said second wireless signal by said bus subscriber;
ascertaining a second signal strength value of said second wireless signal;
storing said second identification tag in said non-volatile memory associated with said bus subscriber;
ascertaining a first signal strength range associated with said signal strength;
ascertaining a second signal strength range associated with said second signal strength; and
selecting said identification tag based on comparison of a first signal strength range associated with said signal and a second signal strength range associated with said second signal.

9. The method according to claim 1, wherein the signal has a fixed preamble used by said bus subscriber to ascertain a signal strength of said signal.

10. The method according to claim 1, wherein said method is performed once during the manufacture of said cooking appliance wherein said cooking appliance comprise said plurality of bus subscribers and said data bus.

11. The method according to claim 1, wherein said method is performed upon initiating operation of said cooking appliance wherein said cooking appliance comprises the data bus and the bus subscribers.

12. A cooking appliance comprising:
a plurality of electronic modules each functioning as bus subscribers, wherein each electronic module further comprises
a signal receiver capable of receiving a wireless transmitted signal conveying a unique identification tag,
an evaluating device evaluating said wireless signal to ascertain whether to allocate said unique identification tag for identifying a subsequently received control message controlling said electronic module, and
a heating element; and
a common data bus interconnecting said plurality of electronic modules, wherein said subsequently received control message is transmitted over said data bus.

13. The device according to claim 12 wherein said evaluating device measures a signal strength of said signal, said evaluating device using said signal strength to allocate said identification tag.

14. The device according to claim 13 further comprising a controller connected to said data bus, wherein a value of said signal strength is communicated using said data bus.

15. An apparatus for allocating identification tags to a cooking appliance, said cooking appliance comprising a data bus and a plurality of bus subscribers, wherein each bus subscriber comprises a hob including a heating element and a wireless receiver, said apparatus comprising:
at least one transmitter for emitting a wireless signal to said bus subscribers, wherein said wireless signal conveys a unique identification tag.

16. The apparatus of claim 15 comprising a plurality of transmitters, wherein each of said plurality of transmitters transmits a respective signal conveying one of a plurality of identification tags to a respective one of said plurality of bus subscribers.

17. The apparatus according to claim 15, wherein said transmitter is movable and can be positioned nearest any one of said plurality of bus subscribers.

18. The apparatus according to claim 15, wherein said transmitter is constructed in such a way an emission angle range is adjustable for directing said signal to a given one of the plurality of bus subscribers.

19. The apparatus according to claim 15, wherein said transmitter is positioned relative to the bus subscribers in such a way that no two bus subscribers have the same distance from the transmitter.

20. Apparatus according to claim 15, characterized in that the apparatus has a control unit able to connect to the data bus.
